(19) United States
(12) Patent Application Publication
(10) Pub. No.: US 2016/0116567 A1
(43) Pub. Date: Apr. 28, 2016

(54) REDUCING INTERFERENCE FROM ADJACENT UNCOORDINATED LOCATIONING SYSTEMS

(71) Applicant: SYMBOL TECHNOLOGIES, INC., SCHAUMBURG, IL (US)

(72) Inventor: RUSSELL E. CALVARESE, STONY BROOK, NY (US)

(21) Appl. No.: 14/520,854

(22) Filed: Oct. 22, 2014

(51) Int. Cl. G01S 5/18

(52) U.S. Cl. CPC G01S 5/18

(57) ABSTRACT

A technique that reduces interference from an adjacent uncoordinated locationing system includes a plurality of transmitters to transmit signals in accordance with a transmission timing sequence. At least one receiver receives said signals. A backend controller can detect interference from an adjacent uncoordinated locationing system using the receiver, whereupon the controller is operable to modify the transmission timing sequence of the signals emitted by the transmitters, and determine a change in the interference in order to select a sequence that minimizes interference. The controller can modify the transmission timing sequence of the signals emitted by those transmitters near the interference and not modify the sequence of the signals emitted by transmitters that are not subject to the interference.

### BACKGROUND

Businesses are beginning to adopt local locationing systems in order to track objects within their establishment. For example, items that are able to send or receive ultrasonic signals can be tracked using flight time based ultrasonic locationing systems, as are known in the art. Flight time based ultrasonic locationing systems typically have a control process to time slice synchronized ultrasonic emitter groups (clusters) such that adjacent clusters don't interfere with each other.

However, businesses generally do not coordinate their control systems between themselves, resulting in possible interference between these uncoordinated locationing systems. Therefore, in a shopping mall or other retail space with multiple nearby locationing systems, each with their own control process, coordination between these systems may not be possible or practical. Such a condition can exist when two different retailers are leasing adjacent stores, for example.

Accordingly, there is a need for a technique to alleviate the above interference issues in uncoordinated nearby ultrasonic locationing systems, without requiring modifications to existing hardware.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system, in accordance with some embodiments of the present invention.

FIG. 2 is a flowchart of a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method is described that mitigates interference issues in uncoordinated nearby locationing systems, without requiring modifications to existing hardware. Although the present invention is described in relation to an ultrasonic locationing system, it should be recognized that the present invention is also applicable to Radio Frequency (RF) locationing systems, including RF Identification (RFID) systems and Wireless Local Area Network (WLAN or Wi-Fi™) systems.

For example, a wireless communication network can include local and wide-area networks, or other IEEE 802.11 wireless communication systems. However, it should be recognized that the present invention is also applicable to other wireless communication systems. For example, the description that follows can apply to one or more communication networks that are IEEE 802.xx-based, employing wireless technologies such as IEEE's 802.11, 802.16, or 802.20, modified to implement embodiments of the present invention. The protocols and messaging needed to establish such networks are known in the art and will not be presented here for the sake of brevity.

Various entities are adapted to support the inventive concepts of the embodiments of the present invention. Those skilled in the art will recognize that the drawings do not depict all of the equipment necessary for system to operate but only those system components and logical entities particularly relevant to the description of embodiments herein. For example, routers, controllers, switches, access points, and mobile devices can all includes separate communication interfaces, transceivers, memories, etc. all under control of a processor. In general, components such as processors, transceivers, memories, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the memory and control aspects of the present invention may be implemented in any of the devices listed above or distributed across such components.

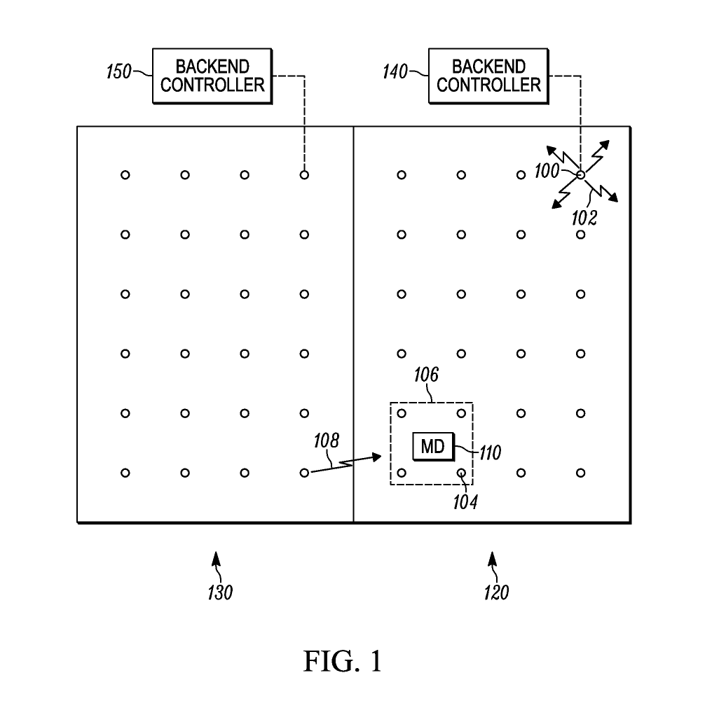

FIG. 1 is a block diagram depiction of a system that reduces interference from an adjacent uncoordinated locationing system, in accordance with some embodiments of the present invention. In the example shown, two adjacent locationing systems 120, 130 are shown, although more adjacent locationing systems may exist. Each locationing system includes a backend controller 140 that controls a plurality of transmitters 100 operable to transmit signals 102 in accordance with a transmission timing sequence. The drawing indicates an example of the control connection and signaling of only one transmitter 100 for the sake of drawing simplicity, and therefore it should be recognized that this same control connection and signaling exists for all the transmitters with respect to the controller. In one embodiment, each transmitter 100 is an ultrasonic emitter, and the signal 102 is an ultrasonic signal that is emitted from each ultrasonic emitter is accordance with a transmission timing sequence for each emitter as established by the backend controller. However, it should be recognized that RF embodiments could be used equally well in the present invention. For example, each transmitter 100 could be an wireless access point, and the signal 102 is an RF signal that is broadcast from each access point is accordance with a transmission timing sequence for each access point as established by the backend controller.

The system includes at least one receiver, such as a mobile device 110 or even in transmitters themselves, operable to receive said signals 102. Signal detection is via microphones (in the ultrasonic embodiment) or RF receivers (in the RF embodiment) that are either added to the receiver, or preferably via existing hardware in the receiver. The time that a signal is received from each transmitter is measured and reported by the receiver to the backend controller wirelessly, for example using an existing WLAN system. The controller, knowing the timing sequence of each transmitter's signal and then the timing of the receipt of the signal received from the receiver, can then determine the location of the mobile device within the environment using time difference of arrival (TDOA) techniques or other locationing techniques, as are known in the art.

A receiver 110 need not receive signals from all transmitters in the system 120 in order for the controller to establish its location. In particular, a receiver needs to receive signals from only two to four nearby transmitters in order for the controller to accurately establish the location of the receiver. In the example shown, mobile device 110 can be properly located by the controller using signal timing measurements from nearby transmitters 104 within a local cluster 106 of transmitters.

Inasmuch as the cluster 106 is located on a fringe of the system environment, it can be subject to interfering signals 108 from an adjacent locationing system. Typically, locationing systems are uncoordinated and not synchronized, and therefore there can be a collision between signals 102, 108 that can result in erroneous timing measurements made by the receiver, which in turn results in mistaken location calculations made by the controller 140. For example, the controller can determine that there is interference within a fringe cluster 106 if the locationing results become erratic or exceed an expected range. The controller can empirically establish a threshold for such erratic or range exceeding results to determine that interference is present in the fringe cluster. If the presence of interference is determined, the backend controller is operable to modify the transmission timing sequence of the signals emitted by the transmitters, and determine a change in the interference resulting in each modification, in order to determine a specific transmission timing sequence that avoids collisions and minimizes interference.

In one embodiment, those fringe clusters that are susceptible to neighboring interference are identified when the system is installed and this information is made available to the controller. Alternatively, fringe clusters are dynamically identified empirically during operation, as indicated by long term trends of a higher than expected number of erratic range measurements such as range measurements exceeding expected results. For example, a range measurement can be measured showing a range outside of the immediate environment, which can be caused by being near an adjacent uncoordinated locationing system.

In one embodiment, the controller is operable to modify the transmission timing sequence of the signals emitted by only those fringe cluster transmitters that are near the interference without modifying the transmission timing sequence of the signals emitted by transmitters that are not subject to the interference, i.e. those transmitters that are not positioned in a fringe cluster close to an adjacent location system. This reduces system control overhead and reduces the number of transmission timing sequence changes that may be needed. Therefore, the present invention identifies those clusters 106 that are on the edge of the covered area and within interfering range of an adjacent uncoordinated system 130. In practice, interference can be detected by a receiver, which can be microphones added to the transmitters or via existing microphones in a mobile device.

If interference 108 is detected by the controller 140 in one of the fringe transmitter clusters 106, the controller can perform several different operations to modify the transmission timing sequence of the signals emitted by the interference affected transmitters. After each modification, the controller can determine a change in the interference to establish which modification to select in order to mitigate the interference problem. Therefore, in accordance with the present invention, a controller deploys one or more alternate scheduling transmission timing sequence modifications for interfered clusters based on at least one of the approaches below.

In one embodiment, the modified transmission sequence consists of a random variance of the transmission timing sequence of the signals emitted by the transmitters of the fringe cluster for at least some time periods, such that the controller can determine a transmission timing sequence for that cluster where interference is minimized.

In another embodiment, when the controller determines that the interference within a cluster exceeds a threshold, the modified transmission timing sequence is changed to a different predefined sequence for that cluster such that the controller can determine which sequence results in minimum interference. In effect, the controller can switch to one of many predefined sequences, effectively settling on a sequence that has little or no interference. The sequences would be crafted specifically to reach this goal using well known time collision approaches, where the timing of the sequence and the receipt time of the interfering signal collide. For example, the controller can determine that there is interference within a fringe cluster if the locationing results become erratic or exceed an expected range. The controller can empirically establish a threshold for such erratic or range exceeding results to determine that interference is present within the fringe cluster.

As an improvement to the last approach, the controller can characterize the interference and construct a transmission timing sequence that produces minimum interference with respect to the characterized interference.

In yet another embodiment, for the case where both of the locationing systems 130, 120 are of the same manufacturing configuration allowing full uncoordinated cooperation, each system can indicate a transmission timing sequence intention to the neighboring locationing system using a specified signal known to both. The specified signal can indicate that the sender will have it transmitters transmit a transmission timing sequence with a predefined inter-pulse interval for predetermined period of time. For example, a specified signal such as a 100 mS 20.0 kHz/21.0 kHz Dual-Tone Multi-Frequency (DTMF) signal or any other specified signal could indicate the intent to transmit a transmission timing sequence with an inter pulse time of 250 mS for the next 5 seconds. Because of the relatively long tone duration, a Fast Fourier Transform performed on many samples can be done allowing a much lower sound pressure level, for the case of ultrasonic emitters. The other system could detect this signal and construct a sequence with little expected interference over the next 5 seconds.

For the above case, where both locationing systems are of the same manufacturing configuration and both have accurate time-of-day clocks synchronized to a time standard having an accuracy corresponding to a resolution of the transmission timing sequence, the controller can synchronously interleave the transmission timing sequence with signals transmitted from the adjacent locationing system. Possible techniques to arrive at the specific sequences have been stated above (to construct, signal or choose on a sequence that results in minimum interference).

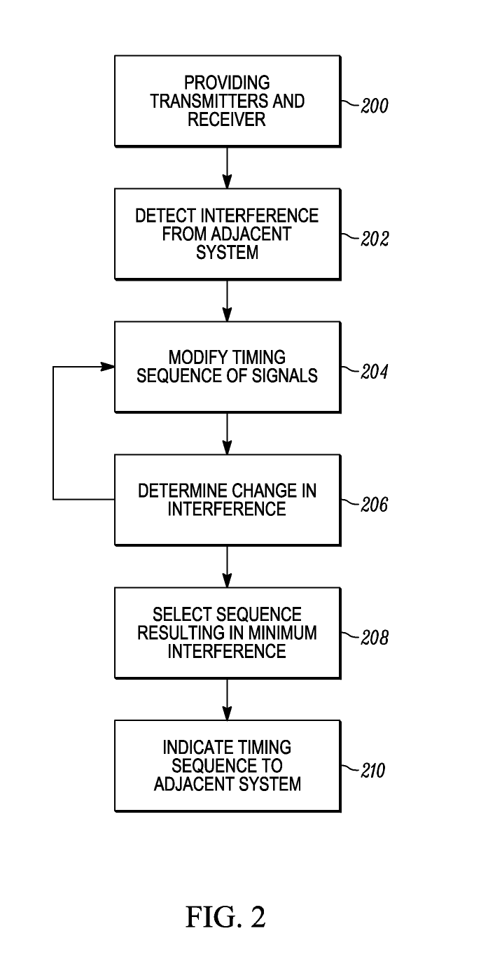

FIG. 2 illustrates a flowchart of a method for reducing interference from an adjacent uncoordinated locationing system, in accordance with the present invention. The method includes providing 200 a plurality of transmitters operable to transmit signals in accordance with a transmission timing sequence, at least one receiver operable to receive said signals, and a backend controller communicatively coupled to the transmitters and the receiver.

A next step includes detecting 202 interference from an adjacent uncoordinated locationing system by the controller using the receiver, and particularly when the interference exceeds a threshold. This step can also include detecting a location of the interference from the adjacent uncoordinated locationing system using the receiver. This step can include detecting when interference exceeds a threshold, whereupon the modified transmission timing sequence is changed to a different predefined sequence such that the controller can determine which sequence results in minimum interference.

A next step includes modifying 204 the transmission timing sequence of the signals emitted by the transmitters. If the location of the interference is known, this step can include modifying the transmission timing sequence of the signals emitted by transmitters near the interference and not modifying the transmission timing sequence of the signals emitted by transmitters that are not subject to the interference.

In one embodiment, modifying includes introducing a random variance of the transmission timing sequence of the signals emitted by transmitters for at least some time periods.

In another embodiment, modifying includes characterizing the interference and constructing a transmission timing sequence that produces minimum interference with respect to the characterized interference.

A next step includes determining 206 a change in the interference, and in particular determining the transmission timing sequence where interference is minimized. Steps 204 and 206 can be repeated for different transmission timing sequences before proceeding to the next step.

A next step includes selecting 208 the transmission timing sequence that results in minimum interference.

Optionally, a next step includes indicating 210 a selected transmission timing sequence intention to the adjacent locationing system. This step can be performed when the controller and adjacent locationing system include time-of-day clocks that are synchronized to a time standard having an accuracy corresponding to a resolution of the transmission timing sequence, and wherein modifying 204 includes synchronously interleaving the transmission timing sequence with signals transmitted from the adjacent locationing system. Indicating can be done using a specified signal to indicate the intent to transmit a transmission timing sequence with a predefined inter-pulse interval for predetermined period of time.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system that reduces interference from an adjacent uncoordinated locationing system, the system comprising:
a plurality of transmitters operable to transmit signals in accordance with a transmission timing sequence;
at least one receiver operable to receive said signals; and
a backend controller communicatively coupled to the transmitters and the receiver, the controller being operable to detect interference from an adjacent uncoordinated locationing system using the receiver, whereupon the controller is operable to modify the transmission timing sequence of the signals emitted by the transmitters, and determine a change in the interference.

2. The system of claim 1, wherein the controller is operable to detect a location of interference from the adjacent uncoordinated locationing system using the receiver, whereupon the controller is operable to modify the transmission timing sequence of the signals emitted by transmitters near the interference and not modifying the transmission timing sequence of the signals emitted by transmitters that are not subject to the interference.

3. The system of claim 1, where the modified transmission sequence consists of a random variance of the transmission timing sequence of the signals emitted by transmitters for at least some time periods, such that the controller can determine a transmission timing sequence where interference is minimized.

4. The system of claim 1, wherein the controller is operable to detect when interference exceeds a threshold, whereupon the modified transmission timing sequence is changed to a different predefined sequence such that the controller can determine which sequence results in minimum interference.

5. The system of claim 4, wherein the controller is operable to characterize the interference and construct a transmission timing sequence that produces minimum interference with respect to the characterized interference.

6. The system of claim 1 wherein the controller is further operable to indicate a transmission timing sequence intention to the adjacent locationing system.

7. The system of claim 6, wherein a specified signal is used to indicate the intent to transmit a transmission timing sequence with a predefined inter-pulse interval for predetermined period of time.

8. The system of claim 6, wherein the controller and adjacent locationing system include time-of-day clocks that are synchronized to a time standard having an accuracy corresponding to a resolution of the transmission timing sequence, and wherein the backend controller synchronously interleaves the transmission timing sequence with signals transmitted from the adjacent locationing system.

9. The system of claim 1 wherein the transmitters are ultrasonic emitters.

10. A system that reduces interference from adjacent uncoordinated ultrasonic locationing systems, the system comprising:
a plurality of ultrasonic emitters operable to emit ultrasonic signals in accordance with a transmission timing sequence;
at least one receiver operable to receive said signals; and
a backend controller communicatively coupled to the emitters and the receiver, the controller being operable to detect interference from an adjacent uncoordinated ultrasonic locationing system using the receiver, whereupon the controller is operable to modify the transmission timing sequence of the ultrasonic signals emitted by the emitters, and determine a change in the interference.

11. A method for reducing interference from an adjacent uncoordinated locationing system, comprising:
providing a plurality of transmitters operable to transmit signals in accordance with a transmission timing sequence, at least one receiver operable to receive said signals, and a backend controller communicatively coupled to the transmitters and the receiver;
detecting interference from an adjacent uncoordinated locationing system;
modifying the transmission timing sequence of the signals emitted by the transmitters; and
determining a change in the interference.

12. The method of claim 11, wherein detecting includes detecting a location of the interference from the adjacent uncoordinated locationing system, and modifying includes modifying the transmission timing sequence of the signals emitted by transmitters near the interference and not modifying the transmission timing sequence of the signals emitted by transmitters that are not subject to the interference.

13. The method of claim 11, wherein modifying includes introducing a random variance of the transmission timing sequence of the signals emitted by transmitters for at least some time periods, such that determining includes determining the transmission timing sequence where interference is minimized.

14. The method of claim 11, wherein detecting includes detecting when interference exceeds a threshold, whereupon the modified transmission timing sequence is changed to a different predefined sequence such that the controller can determine which sequence results in minimum interference.

15. The method of claim 14, wherein modifying includes characterizing the interference and constructing a transmission timing sequence that produces minimum interference with respect to the characterized interference.

16. The method of claim 11, further comprising indicating a transmission timing sequence intention to the adjacent locationing system.

17. The method of claim 16, wherein a specified signal is used to indicate the intent to transmit a transmission timing sequence with a predefined inter-pulse interval for predetermined period of time.

18. The method of claim 16, wherein the controller and adjacent locationing system include time-of-day clocks that are synchronized to a time standard having an accuracy corresponding to a resolution of the transmission timing sequence, and wherein modifying includes synchronously interleaving the transmission timing sequence with signals transmitted from the adjacent locationing system.
